(19) United States
(12) Patent Application Publication
(10) Pub. No.: US 2013/0009581 A1
(43) Pub. Date: Jan. 10, 2013

(54) Motor Converter Circuit for an Electric Drive Motor and Electric Drive Device Having Such a Motor Converter Circuit

(75) Inventors: Goeran Schubert, Schwabach (DE); Manuel Graf, Nuernberg (DE); Markus Fenderl, Simmelsdorf-Oberndorf (DE); Peter Bertelshofer, Zirndorf (DE); Edgar Jerichow, Nuernberg (DE)

(73) Assignee: CONTI TEMIC MICROELECTRONIC GMBH, Nuernberg (DE)

(21) Appl. No.: 13/636,009

(22) PCT Filed: Jan. 19, 2011
(86) PCT No.: PCT/DE2011/000052

§ 371 Date: Sep. 19, 2012

(30) Foreign Application Priority Data
Mar. 19, 2010 (DE) 10 2010 012 210.6

(51) Int. Cl. H02P 6/14

(52) U.S. Cl. 318/400.26

(57) ABSTRACT

An electric drive device (1) comprises a motor converter circuit (3) according to the invention, which includes an intermediate circuit capacitor (16). The intermediate circuit capacitor (16) comprises a parallel circuit of several ceramic capacitors (24). The ceramic capacitors (24) have a lower dissipative resistance and enable better heat removal, so that the motor converter circuit (3) has a comparatively longer service life.

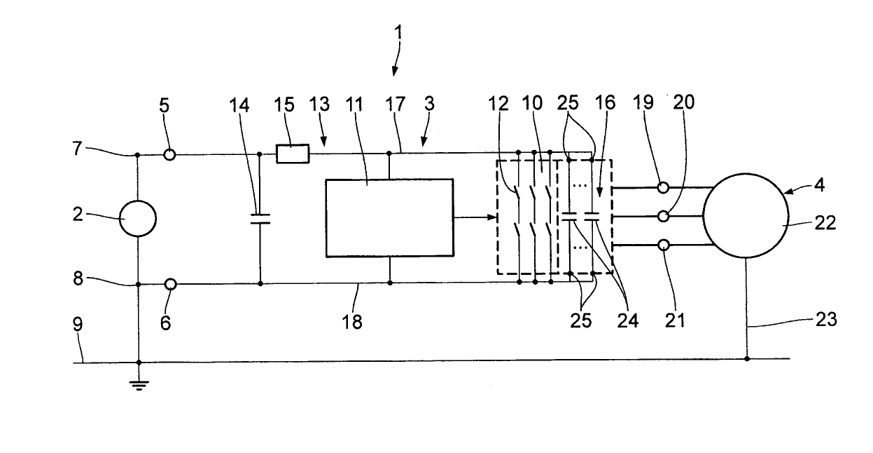

The invention relates to a motor converter circuit according to the preamble of claim 1. The invention further relates to an electric drive device including such a motor converter circuit.

Electric drive devices are used, for example, in the form of electric auxiliary drives in the automation and household appliances industries as well as in rail vehicle technology, automobile technology and aeronautics. In said drive devices, the electric drive motor is connected to a motor converter that is controlled by a converter driver. The motor converter is fed by a voltage source and an intermediate circuit capacitor. The intermediate circuit capacitor is designed as an electrolytic capacitor. The drawback of such motor converter circuits is that the electrolytic capacitors age rapidly in too many cases and, as a consequence, the motor converter circuits fail after a short time.

The object of the invention is to provide a motor converter circuit with a longer service life for use in an electric drive motor.

The aforesaid object is achieved by means of a motor converter circuit having the features set out in claim 1. To ensure that the required EMC limit values are met, the intermediate circuit capacitor is integrated into a so-called n filter. In conventional motor converter circuits, the filter attenuation and the size of the voltage ripples on the output side largely depend on the capacitance, the dissipative resistance and the inductivity of the electrolytic capacitor. Since the ohmic losses in the electrolytic capacitor are so high that the required filter attenuation can just be achieved, it must be ensured that neither the capacitance nor the inductivity of the electrolytic capacitor cause a voltage drop that adds to the dissipative resistance. This is achieved by operating the electrolytic capacitor in series resonance with the fundamental wave of the switching frequency of the motor converter. The consequence are high capacitances, for example in the range from 1 mF to 2 mF for switching frequencies of 20 kHz, and hence physically large components or electrolytic capacitors. Since electrolytic capacitors only tolerate a specific power loss per component, several electrolytic capacitors are connected in parallel to distribute the currents and the associated power loss. For example, two to five electrolytic capacitors are connected in parallel in case of drive motors with a power output of 200 W to 1 kW.

According to the invention, it has been found that there is poor thermal coupling between electrolytic capacitors connected in parallel if the available installation space is small, which causes rapid aging of individual electrolytic capacitors and, in the worst case, failure of the motor converter circuit after a short time. The reason for this is that the electrolytic capacitors have high dissipative resistances on the one hand, and these have negative temperature coefficients on the other. As a consequence, the dissipative resistance of the electrolytic capacitor with the lowest impedance, which carries the highest current, will decrease even further due to the poor removal of waste heat, so that an even higher current will flow through said capacitor, thus further increasing power loss and hence the temperature. This means, said parallel circuit of electrolytic capacitors constitutes a positive-feedback system, which causes rapid aging of electrolytic capacitors with poor thermal coupling.

In contrast, an intermediate circuit capacitor with minimum power loss is provided if several ceramic capacitors are connected in parallel. Each of the ceramic capacitors has a dissipative resistance of 1 mΩ to 2 mΩ, which means that their soldering points or adhesive joints cause more power loss than the ceramic capacitors themselves. If, for example, 50 ceramic capacitors, each with a capacitance of 10 μF, are connected in parallel and each soldering point has a dissipative (ohmic) resistance of 25 mΩ, the resultant dissipative resistance of the intermediate circuit capacitor will be 1 mΩ. This dissipative resistance is approx. 1/20 lower than that of an intermediate circuit capacitor comprising electrolytic capacitors. Said parallel circuit of ceramic capacitors has a lower dissipative resistance on the one hand, thus producing less heat, and comprises a plurality of soldering points on the other, thus enabling better heat removal, compared to the contacts of the capacitive windings of the electrolytic capacitors.

Since the voltage drop associated with the dissipative resistance is reduced by approx. 1/20, a voltage drop at the capacitive reactance of the intermediate circuit capacitor is permissible, so that the intermediate circuit capacitor can be dimensioned with lower capacitive values. The intermediate circuit capacitor need no longer be operated at its resonance. This means, mostly capacitive reactances are connected in parallel at the fundamental frequency and, as a result, the change in dissipative resistance due to heat production and negative temperature coefficients is less relevant.

Furthermore, the partial inductivity that can be regarded as belonging to the intermediate circuit capacitor is several times lower in case of a parallel circuit of ceramic capacitors, compared to electrolytic capacitors. This causes a decrease in quality in the resonance range of the intermediate circuit capacitor and, as a consequence, a smaller voltage drop at higher frequencies, i.e. frequencies that are above the resonance frequency. The result is a wider-band π filter with higher attenuation.

A motor converter circuit according to any one of claims 2 to 5 ensures a long service life.

Another object of the invention is to provide an electric drive device with a longer service life.

This object is achieved by means of an electric drive device having the features set out in claim 6. The advantages of the drive device according to the invention are the same as the advantages of the motor converter circuit according to the invention described above.

Further features, advantages and details of the invention can be seen from the following description of an exemplary embodiment. The figure shows a schematic diagram of an electric drive device including a motor converter according to the invention.

An electric drive device 1 comprises a voltage source 2, which drives an electric drive motor 4 by means of a motor converter circuit 3.

The motor converter circuit 3 comprises two terminals 5, 6, which are connected to the poles 7, 8 of the voltage source 2 or DC voltage source. The first terminal 5 is referred to as K1-30 terminal and the second terminal 6 as K1-31 terminal. The terminal 6 constitutes the ground terminal of the motor converter circuit 3. The pole 8 of the voltage source 2 is connected to a ground conductor 9, which is, for example, the chassis of an automobile or the motor block of an internal-combustion engine.

In order to drive the drive motor 4, the motor converter circuit 3 comprises a motor converter 10, which is driven by means of a converter driver 11. The motor converter 10 or the DC/AC converter is designed as a B6 bridge comprising six power switches 12.

To ensure that the required EMC limit values are met, a π filter 13 is included in the motor converter circuit 3 in the direction of the voltage source 2. The π filter 13 comprises a filter capacitance or a filter capacitor 14 on the input side, which capacitance or capacitor is connected between the terminals 5 and 6. A series circuit comprising an inductivity or corresponding coil 15 and an intermediate circuit capacitance or an intermediate circuit capacitor 16 is connected in parallel to the filter capacitor 14. The converter driver 11 and the motor converter 10 are connected between a connecting line 17, which extends from the coil 15 to the intermediate circuit capacitor 16, and a return conductor 18. On the output side, the motor converter circuit 3 comprises three output terminals 19, 20, 21, which are connected to the drive motor 4. The drive motor 4 is designed as a brushless direct current motor (BLDC motor). The motor housing 22 of the drive motor 4 is connected to the ground conductor 9 by means of a connecting conductor 23.

The intermediate circuit capacitor 16 comprises several ceramic capacitors 24 (cercap) that are connected in parallel to each other. An intermediate capacitor or block capacitor 16 with comparatively little power loss is constructed by connecting for example 50 ceramic capacitors 24, each with a capacitance of 10 μF, in a parallel circuit. Each of the individual ceramic capacitors 24 has a dissipative resistance in the range from 1 mΩ to 2 mΩ, which means that the soldering points or adhesive joints 25 cause more power loss than the ceramic capacitors 24 themselves. In case of a dissipative resistance of approx. 25 mΩ per soldering point 25, the resultant dissipative resistance of the intermediate circuit capacitor 16 is approx. 1 mΩ; this is approx. 1/20 of the dissipative resistance of a conventional intermediate circuit capacitor constructed of electrolytic capacitors.

Thanks to the lower dissipative resistance of the ceramic capacitors 24, there is less power loss and, as a consequence, less heat is produced while at the same time heat removal is improved due to the plurality of soldering points 25. Unlike electrolytic capacitors, the ceramic capacitors 24 will therefore not produce unacceptable amounts of heat and, as a consequence, age rapidly although they also have a negative temperature coefficient. As a result, the motor converter circuit 3 has a comparatively longer service life.

1. A motor converter circuit for an electric drive motor, comprising
a first terminal (5) and a second terminal (6) for connection to a voltage source (2),
a motor converter (10) adapted to drive an electric drive motor (4),
a converter driver (11) adapted to drive the motor converter (10), and
a π filter (13) with
a filter capacitance (14) that is connected to the terminals (4, 5),
an intermediate circuit capacitance (16) that is connected in parallel to the motor converter (10), and
an inductivity (15) that is connected to the first terminal (5) and connected in series with the intermediate circuit capacitance (16), characterized in that
the intermediate circuit capacitance (16) comprises several ceramic capacitors (24) that are connected in parallel with each other in a parallel circuit.

2. A motor converter circuit according to claim 1, characterized in that at least 10, of the ceramic capacitors (24) are connected in parallel with each other in the parallel circuit.

3. A motor converter circuit according to claim 1, characterized in that the parallel circuit of ceramic capacitors (24) is dimensioned such that it is not operated in series resonance with a fundamental wave of a switching frequency of the motor converter (10).

4. A motor converter circuit according to claim 1, characterized in that each of the ceramic capacitors (24) has a dissipative ohmic resistance of not more than 2 mΩ.

5. A motor converter circuit according to claim 1, characterized in that the ceramic capacitors (24) are connected by soldering points (25), and each one of the soldering points has a dissipative ohmic resistance of not more than 25 mΩ.

6. An electric drive device, comprising
a motor converter circuit (3) according to claim 1,
a voltage source (2), having a first pole (7) connected to the first terminal (5) and a second pole (8) connected to the second terminal (6), and
an electric drive motor (4) that is connected to the motor converter (10).

7. A motor converter circuit according to claim 1, characterized in that at least 30 of the ceramic capacitors are connected in parallel with each other in the parallel circuit.

8. A motor converter circuit according to claim 1, characterized in that at least 50 of the ceramic capacitors are connected in parallel with each other in the parallel circuit.

9. A motor converter circuit according to claim 1, characterized in that each of the ceramic capacitors (24) has a dissipative ohmic resistance in a range from 1 mΩ to 2 mΩ.
